(19) United States
(12) Patent Application Publication
(10) Pub. No.: US 2021/0206993 A1
(43) Pub. Date: Jul. 8, 2021

(54) STABILIZATION OF DCOIT IN AQUEOUS SYSTEMS

(71) Applicant: DDP Specialty Electronic Materials US, Inc., Collegeville, PA (US)

(72) Inventors: Timothy DeVries, Collegeville, PA (US); Stacey Barnaby, Collegeville, PA (US); Andrew Camelio, Collegeville, PA (US); Kevin Lawry, Collegeville, PA (US); Daniel Miller, Collegeville, PA (US); Hiteshkumar Dave, Collegeville, PA (US); Marcos Garcia-Bernardi, Collegeville, PA (US)

(21) Appl. No.: 16/772,239

(22) PCT Filed: Dec. 21, 2018
(86) PCT No.: PCT/US2018/067088

§ 371 Date: Jun. 12, 2020

Related U.S. Application Data
(60) Provisional application No. 62/611,115, filed on Dec. 28, 2017.

(51) Int. Cl. C09D 171/02; C09D 7/65; C09D 7/63; C09D 5/02; C09D 133/08

(52) U.S. Cl. CPC C09D 171/02; C09D 7/65; C08K 5/524; C09D 5/025; C09D 133/08; C09D 7/63

(57) ABSTRACT

An aqueous dispersion comprising: (a) at least one of an acrylic polymer and an inorganic pigment; (b) 4,5-dichloro-2-n-octyl-4-isothiazolin-3-one; and (c) an alkyl acetoacetate.

### BACKGROUND

This invention generally relates to stabilized aqueous compositions comprising 4,5-dichloro-2-n-octyl-4-isothiazolin-3-one (DCOIT).

The use of DCOIT in aqueous compositions, including e.g., paints is known. For example, CN106752373 discloses an aqueous ink formulation comprising DCOIT. However, methods of stabilizing DCOIT in aqueous compositions are not always effective, can cause discoloration, and/or are not compatible with coatings compositions.

The problem solved by the present invention is to provide additional methods for stabilizing aqueous compositions comprising DCOIT.

### STATEMENT OF THE INVENTION

The present invention is directed to an aqueous composition comprising: (a) at least one of an acrylic polymer and an inorganic pigment; (b) 4,5-dichloro-2-n-octyl-4-isothiazolin-3-one; and (c) an alkyl acetoacetate.

The present invention is further directed to an aqueous composition comprising: (a) an emulsion polymer; (b) an inorganic pigment; (c) 4,5-dichloro-2-n-octyl-4-isothiazolin-3-one; and (d) an alkyl acetoacetate.

The present invention is further directed to an aqueous composition comprising: (a) 4,5-dichloro-2-n-octyl-4-isothiazolin-3-one; and (b) an aliphatic acid anhydride comprising from four to thirty carbon atoms.

The present invention is further directed to an aqueous composition comprising: (a) 4,5-dichloro-2-n-octyl-4-isothiazolin-3-one; and (b) at least one of: (i) an organic phosphorus acid or salt thereof or (ii) a carboxylic or dicarboxylic acid ester comprising from four to thirty carbon atoms.

### DETAILED DESCRIPTION OF THE INVENTION

All percentages are weight percentages (wt %), all fractions are by weight and all temperatures are in ° C., unless otherwise indicated. Unless otherwise specified all operations are performed at room temperature (20-25° C.). Compounds referred to as “liquid” have melting points no greater than 40° C. (preferably no greater than 30° C.). Percentages of polymerized monomer units in polymers are based on the entire weight of the solid polymer, i.e., excluding water or solvents. Any term containing parentheses refers, alternatively, to the whole term as if no parentheses were present and the term without them, and combinations of each alternative. Thus, the term “(meth)acrylic” refers to any of acrylic, methacrylic, and mixtures thereof. A “C₃-C₆ carboxylic acid monomer” is a mono-ethylenically unsaturated compound having one or two carboxylic acid groups, e.g., (meth)acrylic acid, maleic acid, fumaric acid, itaconic acid, maleic anhydride, crotonic acid, etc. Preferably, the acid monomer has three or four carbon atoms, preferably one carboxylic acid group, preferably (meth)acrylic acid, preferably methacrylic acid (MAA). Alkyl groups are saturated hydrocarbyl groups which may be straight or branched. The term “inorganic” refers to compounds which do not contain carbon, except in the form of carbonate salts.

Crosslinkers are monomers having two or more non-conjugated ethylenically unsaturated groups. Preferred crosslinkers include, e.g., di- or tri-allyl ethers and di- or tri-(meth)acrylyl esters of diols or polyols (e.g., trimethylolpropane diallyl ether (TMPDAE) and trimethylolpropane trimethacrylate (TMPTMA)), di- or tri-allyl esters of di- or tri-acids, allyl (meth)acrylate, divinyl sulfone, triallyl phosphate, divinylaromatics (e.g., divinylbenzene). Preferably, the polymer comprises no more than 0.5 wt % polymerized units of crosslinkers, preferably no more than 0.2 wt %, preferably no more than 0.1 wt %, preferably no more than 0.05 wt %.

Preferably, the aqueous composition comprises a dispersed polymer, preferably an emulsion polymer. Preferably, the polymer is an acrylic, acrylic-styrenic, or polyvinyl acetate polymer. A polyvinyl acetate polymer comprises at least 30 wt % polymerized units of polyvinyl acetate, preferably at least 40 wt %, preferably at least 50 wt %, preferably at least 60 wt %. Polyvinyl acetate polymers may contain polymerized units of acrylic and/or styrenic monomers. An acrylic-styrenic polymer comprises at least 70 wt % polymerized units selected from acrylic monomers and styrenic monomers, preferably at least 80 wt %, preferably at least 90 wt %, preferably at least 95 wt %, preferably at least 98 wt %, preferably at least 99 wt %. An acrylic polymer comprises at least 70 wt % polymerized units selected from acrylic monomers, preferably at least 80 wt %, preferably at least 90 wt %, preferably at least 95 wt %, preferably at least 98 wt %, preferably at least 99 wt %. Acrylic monomers include (meth)acrylic acids and their esters; crotonic acid, itaconic acid, fumaric acid, maleic acid, maleic anhydride, (meth)acrylamides, (meth)acrylonitrile and esters of crotonic acid, itaconic acid, fumaric acid or maleic acid. The acrylic polymer may also comprise other polymerized monomer units including, e.g., vinyl esters of C₁-C₂₂ alkyl carboxylic acids, vinyl amides (including, e.g., N-vinylpyrrolidone), sulfonated acrylic monomers, vinyl sulfonic acid, vinyl halides, phosphorus-containing monomers, heterocyclic monomers and styrenic monomers. Styrenic monomers include 4-methylstyrene, 2-methylstyrene, 3-methylstyrene, 4-methoxystyrene, 2-hydroxymethylstyrene, 4-ethylstyrene, 4-ethoxystyrene, 3,4-dimethylstyrene, 2-chlorostyrene, 3-chlorostyrene, 4-chloro-3-methylstyrene, 4-t-butylstyrene, 2,4-dichlorostyrene, 2,6-dichlorostyrene and vinylnaphthalene; preferably styrene. In a preferred embodiment of the invention the polymer is an acrylic polymer.

Preferably, the polymer comprises at least 70 wt % polymerized units of monomers selected from (meth)acrylic acid, C₁-C₁₂ alkyl (meth)acrylates and styrenic monomers; preferably, at least 75 wt %, preferably at least 80 wt %, preferably at least 85 wt %, preferably at least 90 wt %, preferably at least 95 wt %. Preferably, C₁-C₁₂ alkyl (meth)acrylates are limited to a C₁-C₈ alkyl (meth)acrylates, preferably C₁-C₆ alkyl (meth)acrylates, preferably C₁-C₄ alkyl (meth)acrylates. Preferably the polymer comprises from 5 to 20 wt % polymerized units of (meth)acrylic acid, preferably at least 7 wt %, preferably at least 8 wt %; preferably no more than 17 wt %, preferably no more than 14 wt %. Preferably, the polymer comprises from 1 to 60 wt % polymerized units of styrenic monomers, preferably at least 5 wt %, preferably at least 10 wt %; preferably no more than 55 wt %, preferably no more than 50 wt %. In a preferred embodiment, the polymer comprises at least 70 wt % polymerized units of monomers selected from (meth)acrylic acid and C₁-C₁₂ alkyl (meth)acrylates; preferably, at least 75 wt %, preferably at least 80 wt %, preferably at least 85 wt %, preferably at least 90 wt %, preferably at least 95 wt %.

Preferably, the aqueous composition comprises the polymer as discrete particles dispersed in an aqueous medium, i.e., a polymer latex. In this aqueous dispersion, the average particle diameter of the polymer particles preferably is in the range from 50 to 2000 nm, preferably from 100 to 1000 nm, preferably from 150 to 800 nm. The level of polymer particles in the aqueous dispersion is typically in the range of from 15 to 60 wt %, preferably 25 to 50 wt %, based on the weight of the aqueous dispersion. Preferably, the concentration of DCOIT in the aqueous composition is from 0.01 to 2 wt %; preferably at least 0.05 wt %, preferably at least 0.08 wt %; preferably no more than 1 wt %, preferably no more than 0.5 wt %, preferably no more than 0.15 wt %.

Preferably, the alkyl acetoacetate comprises a C₁-C₁₈ alkyl group, preferably a C₁-C₁₂ alkyl group, preferably a C₁-C₈ alkyl group, preferably a C₁-C₄ alkyl group, preferably methyl or ethyl, preferably ethyl. Preferably, the mole ratio of the acetoacetate to DCOIT is from 0.1:1 to 25:1; preferably at least 0.3:1, preferably at least 0.5:1, preferably at least 1:1, preferably at least 2:1, preferably at least 3:1; preferably no more than 20:1, preferably no more than 17:1, preferably no more than 14:1. Preferably, the alkyl acetoacetate is added to the aqueous composition prior to or together with the addition of DCOIT.

Preferably, the aliphatic acid anhydride is an anhydride of a carboxylic or dicarboxylic acid. Preferably, the aliphatic acid anhydride has from 4 to 25 carbon atoms, preferably from 4 to 20 carbon atoms, preferably from 4 to 18 carbon atoms. In a preferred embodiment, the aliphatic acid anhydride is an alkyl- or alkenyl-substituted succinic acid anhydride, preferably one having only a single alkyl or alkenyl group. Preferably, the alkyl or alkenyl group has from 4 to 20 carbon atoms, preferably from 4 to 18 carbon atoms, preferably from 4 to 12 carbon atoms. Preferably, the aliphatic acid anhydride is a liquid. Preferably, the mole ratio of the anhydride to DCOIT is from 0.1:1 to 20:1; preferably at least 0.3:1, preferably at least 0.5:1, preferably at least 1:1, preferably at least 2:1; preferably no more than 17:1, preferably no more than 14:1, preferably no more than 12:1. Preferably, the aliphatic acid anhydride is added to the aqueous composition prior to or together with the addition of DCOIT.

Preferably, the organic phosphorus acid or salt thereof comprises a phosphate ester of a polyethylene oxide having from 1 to 50 polymerized ethylene oxide units. Preferably, the polyethylene oxide is capped with a hydrocarbyl group having from 1 to 30 carbon atoms, preferably from 1 to 20 carbon atoms, preferably from 6 to 20 carbon atoms. Preferably, the hydrocarbyl group is an aryl or an aryl group with an alkyl substituent; preferably the hydrocarbyl group is phenyl or alkylphenyl. Preferably, the mole ratio of the organic phosphorus acid or salt thereof to DCOIT is from 0.1:1 to 20:1; preferably at least 0.3:1, preferably at least 0.5:1, preferably at least 1:1, preferably at least 2:1; preferably no more than 17:1, preferably no more than 14:1, preferably no more than 12:1. Preferably, the organic phosphorus acid or salt thereof is added to the aqueous composition prior to or together with the addition of DCOIT Preferably, the carboxylic or dicarboxylic acid ester comprising from 4 to 30 carbon atoms is aliphatic, preferably an alkyl ester, preferably a C₁-C₈ alkyl ester, preferably a C₁-C₆ alkyl ester. Preferably, the carboxylic or dicarboxylic ester comprises at least 5 carbon atoms; preferably no more than 25 carbon atoms, preferably no more than 20 carbon atoms, preferably no more than 15 carbon atoms. Preferably, the mole ratio of the carboxylic or dicarboxylic acid ester to DCOIT is from 0.1:1 to 20:1; preferably at least 0.3:1, preferably at least 0.5:1, preferably at least 1:1, preferably at least 2:1; preferably no more than 17:1, preferably no more than 14:1, preferably no more than 12:1. Preferably, the carboxylic or dicarboxylic acid ester is added to the aqueous composition prior to or together with the addition of DCOIT

Typical aqueous emulsion polymerization techniques are suitable for preparation of the acrylic polymer. Aqueous emulsion polymerization processes typically are conducted in an aqueous reaction mixture, which contains at least one monomer and various synthesis adjuvants such as the free radical sources, buffers, and reductants in an aqueous reaction medium. Preferably, polymerization is carried out to obtain random copolymers. Preferably, the aqueous emulsion polymer has M from 100,000 to 2,000,000; preferably at least 300,000, preferably at least 400,000; preferably no more than 1,500,000.

The emulsion of aqueous acrylic polymer particles are useful in coatings applications, e.g., architectural coatings, roof coatings, wood finishes (e.g., wood stains and other protective finishes for wood), industrial coatings, and specialty coatings (automotive, industrial maintenance, traffic marking, and marine). In a preferred embodiment of the invention, the aqueous emulsion of acrylic, styrene-acrylic or polyvinyl acetate polymer is a latex paint or semi-transparent stain which contains inorganic hiding and extender pigment(s) such as titanium dioxide, kaolin, tale, calcium carbonate, nepheline syenite, barite, mica and silica. Preferred pigment ranges are 2-50 wt %, preferably 10-45 wt %.

### EXAMPLES

### Example 1: Inhibitor Testing

A stock solution of binder RHOPLEX™ HG-706 (100 g; The Dow Chemical Company; 100% acrylic latex binder)+BIOBAN™ 200 (0.50 g; The Dow Chemical Company)+anisole (50 μL, as an internal standard) was prepared. A 10 g portion was held at room temperature for 7-9 days; a second 10 g portion was heated to 50° C. in a water bath for the same amount of time; to additional 10 g portions, an inhibitor was added (0.25 mmol), and these were also heated to 50° C. Inhibitor candidates were purchased from Aldrich or TCI, or were acquired from Dow Chemical Company. All inhibitor candidates were used as received.

Mixtures of DCOIT and anisole in binders, either freshly prepared or aged several days at elevated temperature in a closed vial, were diluted at the ratio of 0.5 mL sample to 5 mL acetonitrile, to which were then added aqueous AlCl₃ (0.01 M, 100 mL) and HCl (12.1 M, 8 mL). After shaking to mix thoroughly and allowing to settle for a few hours, the samples were then filtered through a 0.45 micron filter and analyzed by reverse phase HPLC. A photodiode array detector (210-500 nm) was used to measure anisole and DCOIT in each sample.

Percent degradation inhibited was calculated by comparing the DCOIT and anisole peak areas remaining in sample with a given additive to those without which had been heated and kept cool, ((DCOIT/Anisole)_{inhibitor,50° C.}−(DCOIT/Anisole)_{no additive,50° C.})/((DCOIT/Anisole)_{no additive,RT}−(DCOIT/Anisole)_{no additive,50° C.})*100%, such that an amount of DCOIT remaining equal to the sample held at room temperature would give an inhibition of 100%, and an amount remaining equal to the sample held at 50° C. would give an inhibition of 0%. Some additives accelerated the degradation, giving a negative value for inhibition, and some apparently worked better than holding at room temperature, giving values above 100%.

TABLE 1
Anhydrides in RHOPLEX ™ HG-706 acrylic latex binder
(0.25 mmol additive, 0.4 mmol DCOIT)

| Additive | % degradation inhibited |
|---|---|
| 2-Hexen-1-ylsuccinic anhydride | 76% |
| Acetic anhydride | 114% |
| Decanoic anhydride | 25% |
| Decanoic anhydride + hexanes | 25% |
| Dodecenylsuccinic anhydride | 61% |
| Hexanoic anhydride | 76% |
| Isobutyric anhydride | 24% |
| Isooctadecylsuccinic anhydride | 31% |
| Isovaleric anhydride | 33% |
| Nonenylsuccinic anhydride | 89% |
| Pivalic anhydride | 28% |

From these data, the top performing anhydrides were: acetic, hexanoic, nonenylsuccinic, and dodecenylsuccinic. It is worth noting that it was not obvious which anhydrides would work, and therefore they had to be screened in order to determine their stabilizing potential.

TABLE 2
Other Organic Electrophiles in RHOPLEX ™ HG-706 acrylic latex binder
(0.25 mmol additive, 0.4 mmol DCOIT)

| Additive | % degradation inhibited |
|---|---|
| 2,2,6-Trimethyl-1,3-dioxin-4-one | −37% |
| 2-Methylbutyl acetate | 17% |
| Benzyl 2-bromoacetate | −3% |
| Decanoyl chloride | 55% |
| Dichloroacetic acid | −40% |
| Dodecanoyl chloride | 48% |
| Ethyl acetoacetate | 27% |
| Heptanoyl chloride | 36% |
| Isobutyl acetoacetate | −23% |
| Isopropyl acetoacetate | 27% |
| Octanoyl chloride | 39% |

In general, this category performed less well than the anhydrides. Decanolyl chloride, dodecanoyl chloride, octanoyl chloride, heptanoyl chloride, and ethyl acetoacetate were the top performers of the other organic nucleophiles. The chlorides were eliminated due to the safety classification as ‘fatal to inhale’.

TABLE 3
Phosphates, Sulfates, and Borates in RHOPLEX ™
in HG-706 acrylic latex binder
(0.25 mmol additive, 0.4 mmol DCOIT)

| Additive | % degradation inhibited |
|---|---|
| 2-Ethylhexyl diphenyl phosphate | 7% |
| Ammonium lauryl sulfate | 15% |
| Bis(2-ethylhexyl) hydrogen phosphate | 6% |
| Diethyl malonate | 40% |
| Ethyl butyrate | 23% |
| Isoamyl butyrate | 38% |
| Sodium 2-ethylhexyl sulfate | −38% |
| Tributyl phosphate | 11% |
| Triethanolamine lauryl sulfate | 15% |
| Triisopropyl borate | −7% |
| Trimethyl borate | −18% |
| Tris(2-butoxyethyl) phosphate | 5% |
| Tris(2-ethylhexyl) phosphate | −50% |
| Triton H-55 | 36% |
| Triton QS-44 | 46% |
| Triton XQS-20 | 50% |

The top performers in this category were the Triton surfactants (H-55, QS-44, and XQS-20), diethyl malonate, and isoamyl butyrate. The Triton surfactants are polyethylene glycol (1,1,3,3-tetramethylbutyl) phenyl ether phosphates.

TABLE 4
Silanes in RHOPLEX ™ HG-706 acrylic latex binder
(0.25 mmol additive, 0.4 mmol DCOIT)

| Additive | % degradation inhibited |
|---|---|
| Ethyl triethoxysilane | 15% |
| Ethyl triethoxysilane + Ti(OBu)4 | −18% |

### Example 2: 8 Week Stability Testing of Acrylic Latex Paints

Paints tested: Valspar Duramax Semi-Gloss Latex Exterior Paint (low VOC, 100% acrylic, purchased at Lowes store in Oaks, Pa.), and Olympic One Tintable Semi-gloss Latex Enamel Interior Paint and Primer in One (100% acrylic, low VOC, purchased at Lowes store in Oaks, Pa.).

The appropriate amount of liquid additive was added dropwise with a Pasteur or transfer pipette over the course of 3 minutes into paint. The container was closed and sealed before it was mixed with a Red Devil (model 5400) paint shaker for 5 minutes. To the paint with additive, 0.1% DCOIT (by way of BIOBAN™ 200) was added dropwise to paint, and then mixed as described above. This level of BIOBAN 200 delivers 40 ppm Cu⁺². Using a plastic pipette, 10 g of paint sample was transferred into a 10 ml head space vial (1 vial needed/time point tested; Fisher Scientific). For samples where mixtures were tested, additives were either added one at a time or pre-mixed before addition to paint, following the same protocol for mixing that was described in (1). A hand crimper was used to cap the vials before tape was added to ensure a full seal (Agilent Technologies). The vials were incubated at the appropriate temperature (in oven at 50 C or at room temperature, protected from light). Samples were removed from their incubation conditions at designated time points and allowed to equilibrate to room temperature.

From the paint, 0.2 g of the sample was removed and diluted 1:20 into MeOH, sonicated, and passed through a 0.22 μm filter for analysis by high performance liquid chromatography (HPLC) using a flow rate of 2.3 millimeter/minute and monitoring at 280 nm to measure the DCOIT concentration and determine the percent DCOIT remaining.

% DCOIT remaining=[DCOIT]_{time×weeks}/[DCOIT]_{time 0}

Key result: Ethylacetoacetate (EAA), trimethylacetic anhydride and dodecenylsuccinic anhydride (DDSA) stabilize DCOIT in a 100% acrylic latex paint at 50° C. for 8 weeks, when compared to DCOIT alone, in the absence of an additive. The DCOIT formulation was BIOBAN™ 200 biocide.

TABLE 5
% DCOIT Remaining using DDSA (0.1 wt % DCOIT to start
in Valspar semi-gloss exterior Paint at 50° C.)

| | |
|---|---|
| Time | wt % Dodecenylsuccinic anhydride |

| (weeks) | 0 wt % | 0.37 wt % | 0.69 wt % | 0.92 wt % |
|---|---|---|---|---|
| 0 | 105% | 100% | 100% | 100% |
| 2 | 5% | 75% | 86% | 92% |
| 4 | 0% | 55% | 73% | 81% |
| 6 | 0% | 41% | 65% | 68% |
| 8 | 0% | 28% | 56% | 56% |

TABLE 6
% DCOIT Remaining using EAA (0.1 wt % DCOIT to start
in Valspar semi-gloss exterior Paint at 50° C.)

| | |
|---|---|
| Time | wt % ethylacetoacetate |

| (weeks) | 0 wt % | 0.18 wt % | 0.34 wt % | 0.45 wt % |
|---|---|---|---|---|
| 0 | 105% | 100% | 100% | 100% |
| 2 | 5% | 77% | 78% | 82% |
| 4 | 0% | 53% | 55% | 76% |
| 6 | 0% | 34% | 42% | 48% |
| 8 | 0% | 21% | 35% | 40% |

TABLE 7
% DCOIT remaining using trimethylacetic anhydride (0.1 wt % DCOIT
to start in Valspar semi-gloss exterior Paint at 50° C.)

wt % Trimethylacetic anhydride

| Time (weeks) | 0 wt % | 0.64 wt % |
|---|---|---|
| 0 | 105% | 100% |
| 2 | 5% | 89% |
| 4 | 0% | 86% |
| 6 | 0% | 57% |
| 8 | 0% | 56% |

Two additional biocide liquid DCOIT formulations were tested (Tables 8 and 9)

(1) Copper-free DCOIT formulation containing 20% DCOIT, 65% 1-phenoxy-2-propanol and 15% propyleneglycol
(2) ROZONE™ 2000 biocide which when dosed to deliver 0.1% DCOIT, delivers 45 ppm of Cu⁺²

TABLE 8
Analysis of the effect of copper and DDSA in Valspar
semi-gloss exterior Paint with 0.1 wt % DCOIT (50° C.)

| | wt % DCOIT remaining (Valspar Paint) | |
|---|---|---|
| | Copper-free DCOIT | Copper DCOIT |
| Time (weeks) | formulation | formulation |

| wt % DDSA | 0 | 0.92 | 0 | 0.92 |
|---|---|---|---|---|
| 0 | 100% | 100% | 100% | 100% |
| 2 | 69% | 84% | 78% | 84% |
| 4 | 31% | 75% | 45% | 74% |
| 6 | 25% | 62% | 35% | 74% |
| 8 | 17% | 62%* | 27% | 30%* |

The *denotes samples where DDSA negatively impacted the paint rheology. These samples contained bits of solidified paint after they were removed from the oven.

TABLE 9
Analysis of the effect of copper and DDSA in Olympic
One semi-gloss interior paint
DDSA in Olympic One Semi-gloss Interior Paint with
0.1 wt % DCOIT (50° C.)

| | wt % DCOIT remaining | |
|---|---|---|
| | Copper-free DCOIT | Copper DCOIT |
| Time (weeks) | Formulation | Formulation |

| wt % DDSA | 0 | 0.92 | 0 | 0.92 |
|---|---|---|---|---|
| 0 | 100% | 100% | 100% | 100% |
| 2 | 39% | 92% | 99% | 89% |
| 4 | 0% | 78% | 97% | 86% |
| 6 | 0% | 85% | 20% | 89% |
| 8 | 0% | 81% | 0% | 88% |

When DDSA was present, 80-90% of DCOIT remained after 8 weeks, regardless of whether copper was or was not present. When DDSA was not present, DCOIT was completely degraded by 8 weeks, regardless of whether copper was or was not present. These data suggest that copper is not needed to stabilize DOCIT in the presence of the additive DDSA.

TABLE 10
% DCOIT remaining in the presence of mixtures of EAA + DDSA
(0.1 wt % DCOIT to start in Valspar semi-gloss exterior paint at 50 C.)

| | | wt % additives (additives separately added to paint) | | | | | |
|---|---|---|---|---|---|---|---|
| | | 0.6 wt % | 0.57 wt % | 0.51 wt % | 0.46 wt % | 0.43 wt % | 0.27 wt % |
| Time | | 3:1 | 2:1 | 1:1 | 1:2 | 1:3 | 1:1 |
| (weeks) | 0 wt % | DDSA:EAA | DDSA:EAA | DDSA:EAA | DDSA:EAA | DDSA:EAA | DDSA:EAA |
| 0 | 105% | 100% | 100% | 100% | 100% | 100% | 100% |
| 2 | 5% | 74% | 69% | 72% | 66% | 70% | 68% |
| 4 | 0% | 73% | 78% | 66% | 64% | 56% | 49% |
| 6 | 0% | 55% | 59% | 51% | 50% | 52% | 42% |
| 8 | 0% | 46% | 47% | 39% | 42% | 37% | 32% |

For these samples, order of addition had no effect on DCOIT stability. Additives were either pre-mixed or added one at a time, with no effect on DCOIT stability observed for order of additive addition.

1. An aqueous dispersion comprising: (a) at least one of an acrylic polymer and an inorganic pigment; (b) 4,5-dichloro-2-n-octyl-4-isothiazolin-3-one; and (c) an alkyl acetoacetate.

2. The aqueous dispersion of claim 1 in which the acrylic polymer comprises at least 75 wt % polymerized units of monomers selected from (meth)acrylic acid and C₁-C₁₂ alkyl (meth)acrylates and the inorganic pigment is selected from the group consisting of titanium dioxide, kaolin, talc, calcium carbonate, nepheline syenite, barite, mica, silica and combinations thereof.

3. The aqueous dispersion of claim 2 in which a mole ratio of the alkyl acetoacetate to 4,5-dichloro-2-n-octyl-4-isothiazolin-3-one is from 0.3:1 to 20:1.

4. An aqueous composition comprising: (a) an emulsion polymer; (b) an inorganic pigment; (c) 4,5-dichloro-2-n-octyl-4-isothiazolin-3-one; and (d) an alkyl acetoacetate.

5. An aqueous composition comprising: (a) 4,5-dichloro-2-n-octyl-4-isothiazolin-3-one; and (b) an aliphatic acid anhydride comprising from four to thirty carbon atoms.

6. The aqueous dispersion of claim 5 in which a mole ratio of the anhydride to 4,5-dichloro-2-n-octyl-4-isothiazolin-3-one is from 0.3:1 to 20:1.

7. The aqueous dispersion of claim 6 in which the aliphatic acid anhydride is an anhydride of an aliphatic carboxylic or dicarboxylic acid.

8. An aqueous composition comprising: (a) 4,5-dichloro-2-n-octyl-4-isothiazolin-3-one; and (b) at least one of: (i) an organic phosphorus acid or salt thereof or (ii) a carboxylic or dicarboxylic acid ester comprising from four to thirty carbon atoms.

9. The aqueous dispersion of claim 8 in which a mole ratio of the organic phosphorus acid or salt thereof or the carboxylic or dicarboxylic acid ester to DCOIT is from 0.3:1 to 20:1.

10. The aqueous dispersion of claim 9 in which the organic phosphorus acid or salt thereof comprises a polyethylene glycol (1,1,3,3-tetramethylbutyl) phenyl ether phosphate having from 1 to 50 polymerized ethylene oxide units and the carboxylic or dicarboxylic acid ester comprising from 4 to 30 carbon atoms is an aliphatic ester.
